(19) United States
(12) Patent Application Publication
(10) Pub. No.: US 2015/0187156 A1
(43) Pub. Date: Jul. 2, 2015

(54) COIN DEPOSIT AND SUMMATION MEMORY DEVICE

(71) Applicant: Huannan WU, FUJIAN (CN)

(72) Inventor: Huannan WU, FUJIAN (CN)

(21) Appl. No.: 14/645,396

(22) Filed: Mar. 11, 2015

Related U.S. Application Data
(63) Continuation-in-part of application No. PCT/CN2013/085889, filed on Oct. 24, 2013.

(30) Foreign Application Priority Data
Dec. 25, 2012 (CN) 201210569640.5
Mar. 15, 2013 (CN) 201310083322.2

(51) Int. Cl. G07D 3/16; G07D 9/04; G07D 5/02

(52) U.S. Cl. CPC G07D 3/16; G07D 5/02; G07D 9/04

(57) ABSTRACT

A coin deposit and summation memory device having a coin denomination identification mechanism and a coin denomination summation mechanism. The device, based on diameter features of different coin denominations, determines different mechanical action characteristic circulations, with a different mechanical feature circulation path driving a characteristic mechanical signal/mechanical action corresponding to the coin denomination; the characteristic mechanical signal corresponding to the coin denomination drives a mechanical counter wheel that, according to the characteristic mechanical signal, does the data summation once that corresponds to the coin denomination. The present invention, able to achieve identification and summation of the 20-ary (0.5 basic unit) or 40-ary (0.25 basic unit) or 50-ary (0.20 basic unit) coin denomination, solves the problem of using a coin slot to circularly identify different denominations of coins and sum up the denominations of the identified coins, having a reasonable structure, convenience for use and other advantages.

### BACKGROUND OF THE INVENTION

The present invention discloses a coin deposit and summation memory device that belongs to the coin deposit technical field according to the International Patent Classification (IPC), particularly a mechanical coin denomination summation memory device that is applied to a moneybox or other deposit handicraft products, which is applicable to summation of the 20-ary, 40-ary and 50-ary minimum coin unit.

A traditional moneybox is a coin container that receives coins through a coin slot. However, a user of the moneybox does not know how many coins have been put into the moneybox. A deposit device has appeared on the market comprising a counter for the number of coins. Because of different coin denominations, such as 1-dime coins, 5-dime coins and 1-dollar coins, the above device can memorize the total number of the deposited coins, but cannot distinguish between denominations and thus cannot do the summation according to denominations. Besides, the existing counter for the number of coins, generally using decimal summation, cannot do the 0.5-unit summation. An existing coin moneybox realized by electronic intelligence, although able to achieve the denomination summation function, needs an electric circuit and has to consume electric energy, and cannot be used without electricity, with the depleted battery having to be abandoned and replaced, not meeting the low-carbon environmental requirements.

The Chinese literature CN200420091104.X discloses an intelligent counting moneybox comprising an upper cover, a counting component, a dialing component, a casing component and a bottom cover component, which can both count while the coins are deposited and open the door automatically after the deposited coins reach a certain amount. The Chinese literature CN200720061699.8 discloses a coin deposit accumulator, in which each time a coin is deposited, the drive component will drive the corresponding counting roulette to rotate once, and meanwhile a group of digits displayed on the display window will be added up once, thereby achieving the summation and display function for the coins. However, the solutions disclosed by the above two literatures are just summation of quantity, without solving the problem of denomination summation.

### BRIEF SUMMARY OF THE INVENTION

Aiming at the shortcomings of the prior art, the present invention provides a mechanical coin deposit and summation memory device having a reasonable structure, which is a universal device judging denomination and doing summation according to the coin diameter.

In order to attain the above purpose, the present invention adopts the following technical solutions:

The first solution: A coin deposit and summation memory device is provided, comprising a coin denomination identification mechanism and a coin denomination summation mechanism, wherein:

the coin denomination identification mechanism includes a frame provided at an end with a coin slot, which has a moveable end to adapt to different diameters of deposited coins; the moveable end is provided with a mover having a drive needle, with the mover moving along a composite slash track and cooperating with a sorting gate to perform sorting operation on different denominations of coins; the sorting gate has more than one channels respectively corresponding to different denomination of coins, with each of the channels provided with a drive rod that has interaction with the drive needle entering the channel to thereby generate a characteristic signal corresponding to the coin denomination; and

the coin denomination summation mechanism includes a set of one-way rotary counter wheels, with the counter wheels of units and tens provided with a one-way drive ratchet; the ratchet is connected with a drive mechanism to receive the characteristic signal sent from the coin denomination identification mechanism and correspondingly drives to thus achieve the coin denomination summation memory.

Furthermore, the moveable end is a moveable fender, which reciprocates along the direction of the coin slot of the frame and is provided with a lateral chute for receiving the mover; the moveable end, while moving horizontally and linearly, drives the mover to move vertically, with the mover also having interaction with a slope spring leaf and a compression spring to form a composite-slash-track traveling path; the movement of the mover is also restricted by the sorting gate, with each of the channels of the sorting gate having a blocking gate; with blocking length of the blocking gate in the linear movement direction corresponding to diameter of the coin, coins of different diameters cause different distance of linear movement of the moveable end, making the mover jump in translation to make the drive needle enter different channels to achieve the coin denomination identification.

Furthermore, the blocking gates in the sorting gate are arranged based on the blocking length from small to large, which causes the drive needle to pass the blocking length from small to large during translation from small to large, making characteristic diameter of each coin correspond to a characteristic return channel.

Furthermore, the moveable fender is connected on both ends with the frame through a tension spring to get reset after the coin is deposited, with the moveable end producing a maximum translation corresponding to the coin diameter in the process of the coin passing the coin slot; the drive needle of the mover in the fender enters different return channels after the maximum jump translation, and then acts on a drive rod slope and is in linkage to the coin denomination summation mechanism to achieve the coin denomination summation memory; the drive needle gets separated when reaching the end of the drive rod slope, and moves back to the initial position under the action of the compression spring, thus completing the cycle.

Furthermore, the drive mechanism, as a gear engaging mechanism, comprises a sector gear set, wherein the sector gear has a trigger end that has interaction with the drive rod to receive the coin sorting characteristic signal, and tooth portion of the sector gear is engaged with a gear on the side of the counter wheel and drives the counter wheel to achieve the coin denomination summation memory.

Furthermore, the coin denomination summation mechanism includes a set of one-way rotary counter wheels, each of the counter wheels being marked on its annular ring with a scale, the counter wheels composing a group of digits for indicating denomination of the deposited coin; each of the counter wheels is provided inside with a one-way positioning ratchet, with the counter wheels of units and tens provided with a one-way drive ratchet; a drive mechanical signal to which mechanical sorting denomination of the coin denomination identification mechanism corresponds acts on an outer gear of the ratchet of units or tens through the drive mechanism and drives the counter wheel to rotate; each of the counter wheels is provided on the right periphery with several count linkage teeth and on the left periphery with a carry linkage tooth, with a linkage wheel provided between the adjacent counter wheels for linkage carry:

a wheel of units, used for summation of 1-dime coins, driven by one drive rod, used for summation of a whole unit, doing carry linkage on the wheel of tens once reaching ten units; and

a wheel of tens, used for summation of 5-dime and 10-dime (1-dollar) coins, driven by two drive rods, having a whole-unit carry and a semi-unit carry, producing carry linkage with the wheel of hundreds once reaching ten, or doing carry per 0.5 unit and completing carry by two linkages.

Furthermore, the sector gear set comprises a first drive wheel and a second compound wheel, both of which are blocked on one side to the initial position; the first drive wheel has interaction with a drive rod and is in linkage with the wheel of units, delivering one kind of denomination signal; the second compound wheel has interaction with the two drive rods to be in linkage with the wheel of tens, delivering two kinds of denomination signals; the second compound wheel is composed of an active wheel and a passive sector wheel, the active wheel being provided with a reset connection hole for connecting a spring and elastically fixed in the initial position, the passive sector wheel being in differential drive with the active wheel, the drive rod having mechanical action on the active wheel; the active wheel, when going through a rotating difference process with the passive sector wheel, delivers a mechanical signal, which acts on a clutch frame of the linkage wheel on the counter wheel to get the linkage wheel separated/reunited; the active wheel, after differential rotation relative to the passive wheel, gets in linkage with the passive sector wheel, and gets engaged and in linkage with the drive ratchet on the counter wheel through this sector wheel.

Furthermore, the linkage wheel between the counter wheels of units and tens is mounted on the clutch frame, which is positioned on a base by the elastic member and controlled by the active wheel of the second compound wheel, with the linkage wheel separated from the counter wheel during the carry interference.

The second solution: A coin deposit and summation memory device is provided, comprising a coin denomination identification mechanism and a coin denomination summation mechanism, wherein:

the coin denomination identification mechanism includes a frame provided at an end with a coin slot, which has a moveable end to adapt to different diameters of deposited coins; the moveable end is provided with a mover having a drive needle, with the mover moving along a composite slash track and cooperating with a sorting gate to perform sorting operation on different denominations of coins; the sorting gate has more than one channels respectively corresponding to different denomination of coins, with each of the channels provided with a drive rod that has interaction with the drive needle entering the channel to thereby generate a characteristic signal corresponding to the coin denomination; and

the coin denomination summation mechanism includes a set of one-way rotary counter wheels, with the counter wheels of units, tens and hundreds provided with a one-way drive ratchet; the ratchet is connected with a drive mechanism to receive the characteristic signal sent from the coin denomination identification mechanism and correspondingly drives to thus achieve the coin denomination summation memory.

Furthermore, the moveable end is a moveable fender, which reciprocates along the direction of the coin slot of the frame and is provided with a lateral chute for receiving the mover; the moveable end, while moving horizontally and linearly, drives the mover to move vertically, with the mover also having interaction with a slope spring and a compression spring to form a composite-slash-track traveling path; the movement of the mover is also restricted by the sorting gate, with each of the channels of the sorting gate having a blocking gate; with blocking length of the blocking gate in the linear movement direction corresponding to diameter of the coin, coins of different diameters cause different distance of linear movement of the moveable end, making the mover jump in translation to make the drive needle enter different channels to achieve the coin denomination identification.

Furthermore, the blocking gates in the sorting gate are arranged based on the blocking length from small to large, which causes the drive needle to pass the blocking length from small to large during translation from small to large, making characteristic diameter of each coin correspond to a characteristic return channel.

Furthermore, the moveable fender is connected on both ends with the frame through a tension spring to get reset after the coin is deposited, with the moveable end producing a maximum translation corresponding to the coin diameter in the process of the coin passing the coin slot; the drive needle of the mover in the fender enters different return channels after the maximum jump translation, and then acts on a drive rod slope and is in linkage to the coin denomination summation mechanism to achieve the coin denomination summation memory; the drive needle gets separated when reaching the end of the drive rod slope, and moves back to the initial position under the action of the compression spring, thus completing the cycle.

Furthermore, the drive mechanism, as a gear engaging mechanism, comprises a sector gear set, wherein the sector gear has a trigger end that has interaction with the drive rod to receive the coin sorting characteristic signal, and tooth portion of the sector gear is engaged with a gear on the side of the counter wheel and drives the counter wheel to achieve the coin denomination summation memory.

Furthermore, there is a scale on each of the counter wheels of the coin denomination summation mechanism, the counter wheels composing a group of digits for indicating denomination of the deposited coin, the counter wheels of units, tens and hundreds being provided with a one-way drive ratchet; a drive mechanical signal to which mechanical sorting denomination of the coin denomination identification mechanism corresponds acts on an outer gear of the ratchet of units, tens or hundreds through the drive mechanism and drives the counter wheel to rotate; each of the counter wheels is provided on the right periphery with several count linkage teeth and on the left side with a carry linkage tooth, with a linkage wheel provided between the adjacent counter wheels for linkage carry:

a wheel of units, used for summation of 1-cent coins, driven by one drive rod, used for summation of a whole unit, doing carry linkage on the wheel of tens once reaching ten units;

a wheel of tens, used for summation of 5-cent, 1-dime and 25-cent coins, driven by three drive rods, having a whole-unit carry and a semi-unit carry, producing carry linkage with the wheel of hundreds once reaching ten, or doing carry per 0.5 unit and completing carry by two linkages; and

a wheel of hundreds, used for summation of 5-dime and 1-dollar coins, driven by two drive rods, having a whole-unit carry and a semi-unit carry, producing carry linkage with the wheel of thousands once reaching ten, or doing carry per 0.5 unit and completing carry by two linkages.

Furthermore, the sector gear set comprises a first drive wheel, a second compound wheel, and a third compound wheel, three of which are blocked on one side to the initial position; the first drive wheel has interaction with a drive rod and is in linkage with the wheel of units, delivering one kind of denomination signal; the second compound wheel has interaction with the three drive rods to be in linkage with the wheel of tens, delivering three kinds of denomination signals; the third compound wheel has interaction with the two drive rods to be in linkage with the wheel of hundreds, delivering two kinds of denomination signals.

Furthermore, the first drive wheel, the second compound wheel and the third compound wheel are all composed of an active wheel and a passive sector wheel; the active wheel is provided with a torsion spring and elastically fixed in the initial position, with one end of the torsion spring abutting against a first column; the drive rod has mechanical action on the active wheel, which is provided with a lug; wherein the lug on the active wheel of the first drive wheel is inserted into a mounting hole of the passive sector wheel of the first drive wheel, the lug on the active wheel of the second compound wheel is located in a differential hole of the passive sector wheel of the second compound wheel, and the lug on the active wheel of the third compound wheel is located in a differential hole of the passive sector wheel of the third compound wheel, with the lug on the active wheel of the second compound wheel and the third compound wheel able to be relatively displaced in the differential hole, thus achieving differential drive with the passive sector wheel; the active wheel of the second compound wheel and the third compound wheel, in the process of rotation difference with the passive sector wheel, delivers a mechanical signal, which acts on a clutch frame of the linkage wheel on the counter wheel to get the linkage wheel separated/reunited; the active wheel, after differential rotation relative to the passive wheel, gets in linkage with the passive sector wheel, and gets engaged and in linkage with the drive ratchet on the counter wheel through this sector wheel.

Furthermore, the linkage wheels between the counter wheels are mounted on the clutch frame to which they respectively correspond, with the clutch frame positioned by the elastic member; the active wheel of the second compound wheel controls the clutch frame to which the linkage wheel between the counter wheels of units and tens corresponds, and the active wheel of the third compound wheel controls the clutch frame to which the linkage wheel between the counter wheels of tens and hundreds corresponds, making the linkage wheel separated from the counter wheel during the carry interference.

Furthermore, the clutch frame is provided with a positioning elastic sheet, one end of which acts on the tooth position of the linkage wheel; the coin denomination summation mechanism also comprises a one-way clipping spring leaf, whose spring leaf cooperates in positioning with the count linkage tooth on the right periphery of the counter wheel.

Furthermore, the sorting gate is provided above with an upper cover plate, which is provided with a blocking gate that is symmetrical to the blocking gate of the sorting gate so as to make the mover subjected to a force symmetrically; the coin denomination identification mechanism and the coin denomination summation mechanism are disposed on a chassis.

In the above two solutions, the coin deposit and summation memory device can achieve identification and summation of 20-ary, 40-ary or 50-ary coin denomination, which corresponds to a minimum scale of 0.50 unit, 0.25 unit and 0.20 unit, respectively.

The 0.5-unit counting is done as follows in the present invention: The counter wheel rotates by 20 teeth per circle at the minimum rotation of 18 degrees, i.e. rotating by twenty 18 degrees (360 degrees) to complete a circle; the digits on the counter wheel are decimal digits familiar to people at the minimum unit of 0.5 unit, i.e. using twenty 0.5 unit (10 units) to complete a circle.

Certainly, two 0.5 units can also be counted together, i.e. counting by 1 basic unit. The counting by 1 basic unit is done as follows: The counter wheel rotates by 10 teeth per circle at the minimum rotation of 36 degrees, i.e. rotating by ten 36 degrees (360 degrees) to complete a circle; the digits on the counter wheel are decimal digits familiar to people at the minimum unit of 1 unit, i.e. using ten 1 unit (10 units) to complete a circle.

The operational principle of the present invention is as follows: The present invention, based on diameter features of different coin denominations, determines different mechanical action characteristic circulations, with a different mechanical feature circulation path driving a characteristic mechanical signal/mechanical action corresponding to the coin denomination; the characteristic mechanical signal corresponding to the coin denomination drives a mechanical counter wheel that, according to the characteristic mechanical signal, does the data summation once that corresponds to the coin denomination.

The present invention has the following beneficial effects:

1. The present invention is pure mechanical in structure, meeting the low-carbon environmental requirements.

2. The present invention achieves the denomination summation memory of a moneybox.

3. The present invention solves the problem of using a coin slot to circularly identify different denominations of coins and sum up the denominations of the identified coins.

4. The present invention provides the fractional summation of coin denominations. For example, 0.5 unit, as the smallest scale of a 20-ary counter wheel, is applied to summation of the coins similar to 5 dimes (0.5 dollar); 0.25 unit, as the smallest scale of a 40-ary counter wheel, is applied to summation of the coins similar to 25 US cents (0.25 US dollar); 0.20 unit, as the smallest scale of a 50-ary counter wheel, is applied to summation of the coins similar to 20 euro cents (0.2 euro).

### BRIEF DESCRIPTION OF THE DRAWINGS

FIG. 1 is a schematic drawing of the coin deposit and summation memory device of Example 1 of the present invention.

FIG. 2 is a side view of FIG. 1.

FIG. 3 is a top view of FIG. 1.

FIG. 4 is another schematic drawing of the coin deposit and summation memory device of Example 1 of the present invention.

FIG. 5 is a schematic drawing of Example 1 of the present invention, wherein the coin denomination identification mechanism and the coin denomination summation mechanism are separated.

FIG. 6 is a schematic drawing of the coin denomination identification mechanism of Example 1 of the present invention.

FIG. 7 is a separated schematic drawing of the sorting gate of the coin denomination identification mechanism of Example 1 of the present invention.

FIG. 8 is a schematic drawing of the frame, the fender and the mover of the coin denomination identification mechanism of Example 1 of the present invention.

FIG. 9 is a structural drawing of the sorting gate of the coin denomination identification mechanism of Example 1 of the present invention.

FIG. 10 is a schematic drawing of the coin denomination summation mechanism of Example 1 of the present invention.

FIG. 11 is a structural drawing of carry linkage of the summation mechanism of Example 1 of the present invention.

FIG. 12 is a schematic drawing of the drive rod in interaction with the sector gear set of Example 1 of the present invention.

FIG. 13 is a schematic drawing of the sector gear set of Example 1 of the present invention.

FIG. 14 is a schematic drawing of the coin deposit and summation memory device of Example 2 of the present invention.

FIG. 15 is a schematic drawing of the coin deposit and summation memory device of Example 2 of the present invention, wherein the upper cover is not shown.

FIG. 16 is a side view of FIG. 15.

FIG. 17 is a schematic drawing of partial structure of the coin deposit and summation memory device of Example 2 of the present invention.

FIG. 18 is a schematic drawing of another partial structure of the coin deposit and summation memory device of Example 2 of the present invention.

FIG. 19 is a schematic drawing of the moveable frame of Example 2 of the present invention.

FIG. 20 is a schematic drawing of the drive rod in interaction with the sector gear set of Example 2 of the present invention.

FIG. 21 is a side view of FIG. 20.

FIG. 22 is an exploded view of partial structure of the sector gear set of Example 2 of the present invention.

FIG. 23 is a contrast drawing of the first drive wheel to the second compound wheel or the third compound wheel of Example 2 of the present invention.

FIG. 24 is a schematic drawing of the clutch frame of Example 2 of the present invention.

FIG. 25 is a schematic drawing of the linkage wheel and the positioning elastic sheet of Example 2 of the present invention.

FIG. 26 is a schematic drawing of the upper cover plate and the sorting gate of Example 2 of the present invention.

### DETAILED DESCRIPTION OF THE INVENTION

The present invention will be further described below with reference to the drawings.

### Example 1

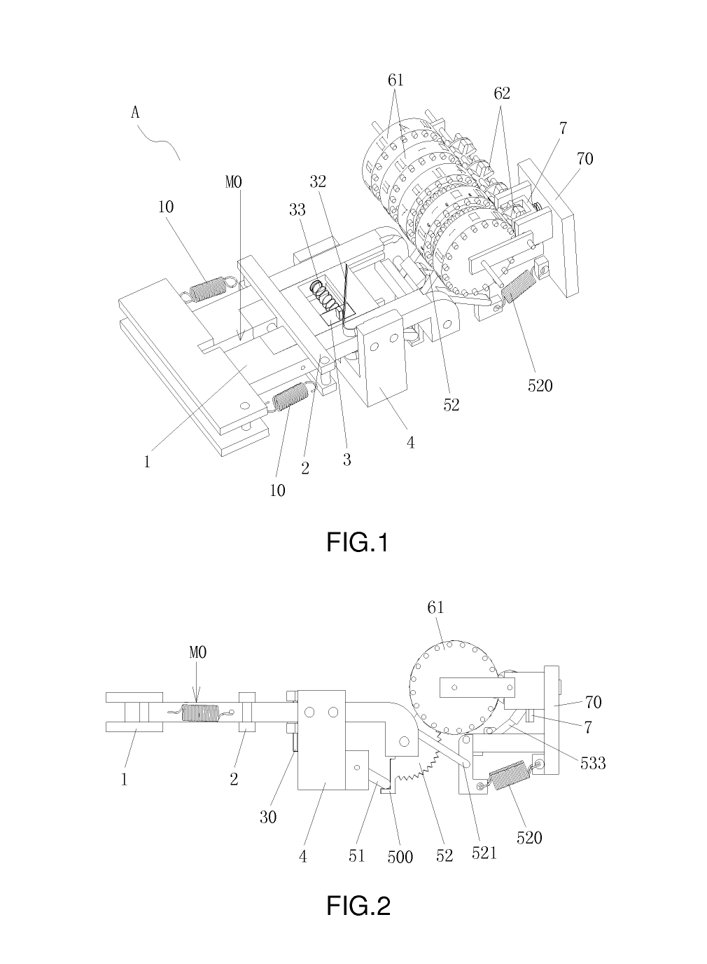

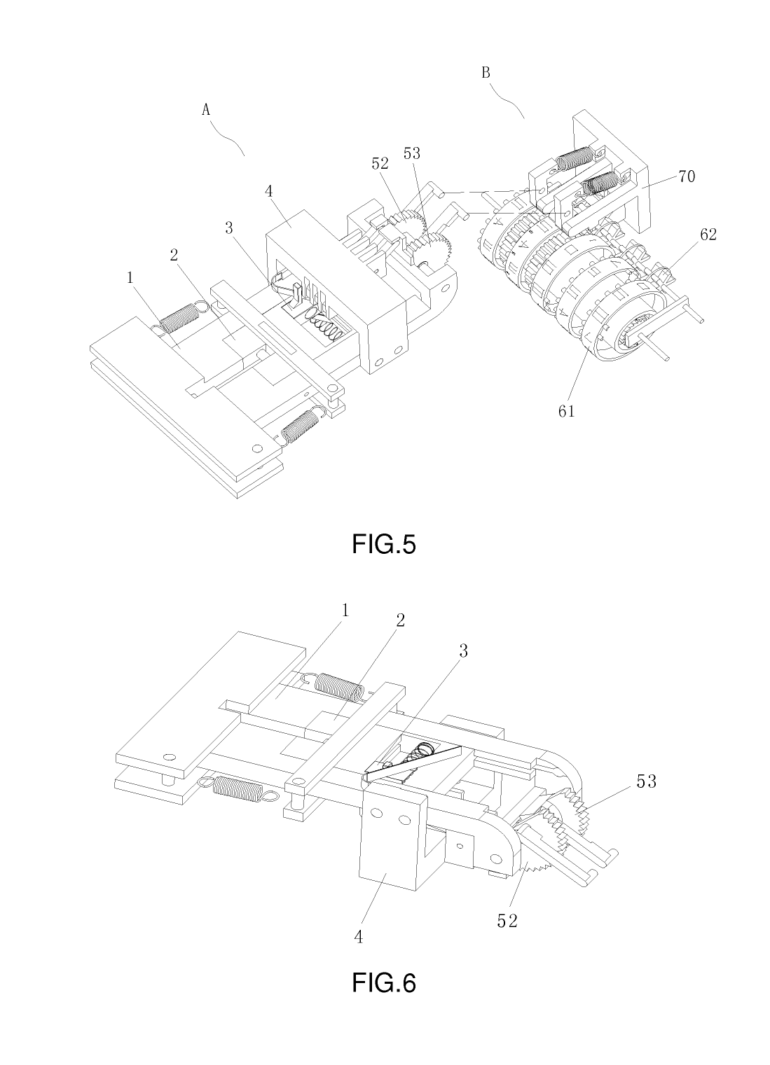

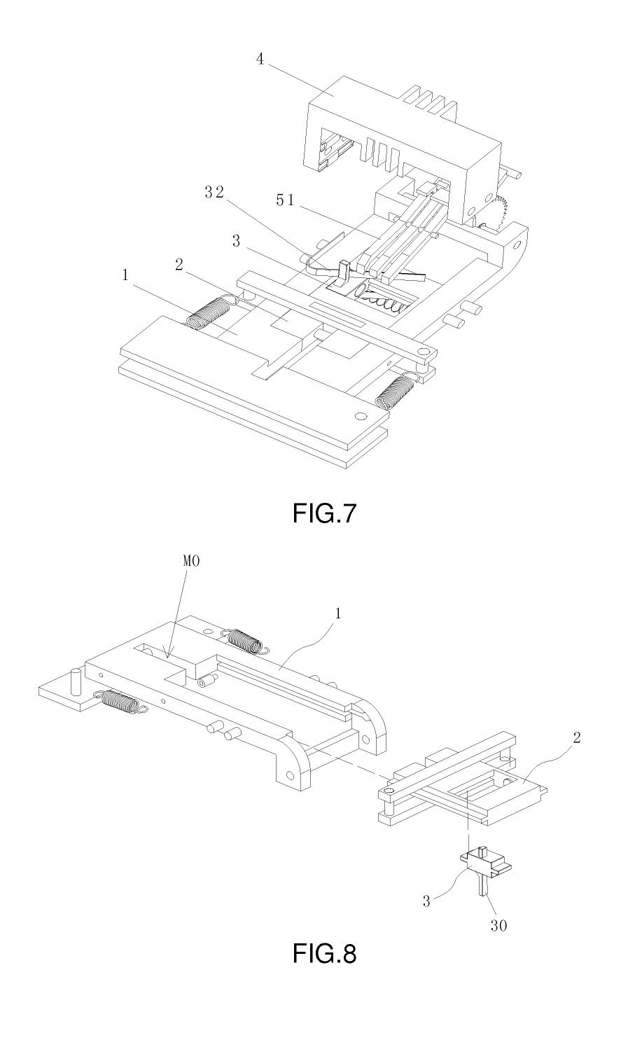

As shown in FIGS. 1 to 5, a coin deposit and summation memory device is provided, comprising a coin denomination identification mechanism A and a coin denomination summation mechanism B, wherein:

the coin denomination identification mechanism A includes a frame 1 provided at an end with a coin slot MO, which has a moveable end (a moveable frame 2) to adapt to different diameters of deposited coins; the moveable end is provided with a mover 3 having a drive needle 30, with the mover 3 moving along a composite slash track and cooperating with a sorting gate 4 to perform sorting operation on different denominations of coins; the sorting gate 4 has more than one channels respectively corresponding to different denomination of coins, with each of the channels provided with a drive rod that has interaction with the drive needle 30 entering the channel to thereby generate a characteristic signal corresponding to the coin denomination;

the coin denomination summation mechanism B includes a set of one-way rotary counter wheels 61, with the counter wheels of units and tens provided with a one-way drive ratchet; the ratchet is connected with a drive mechanism 5 to receive the characteristic signal sent from the coin denomination identification mechanism and correspondingly drives to thus achieve the coin denomination summation memory.

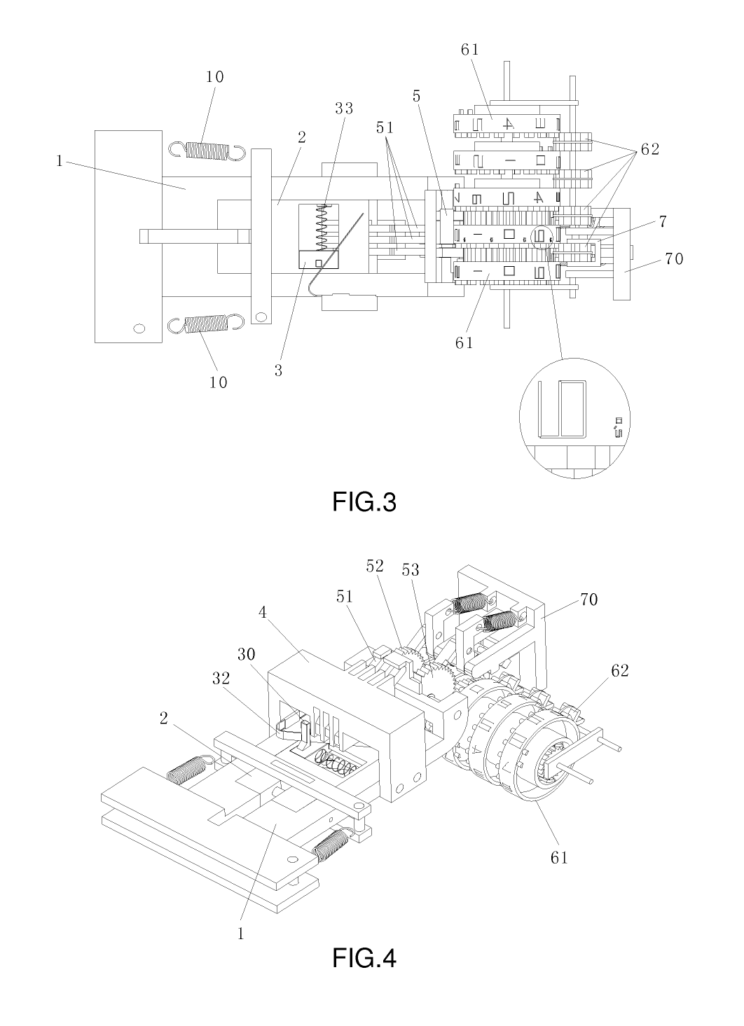

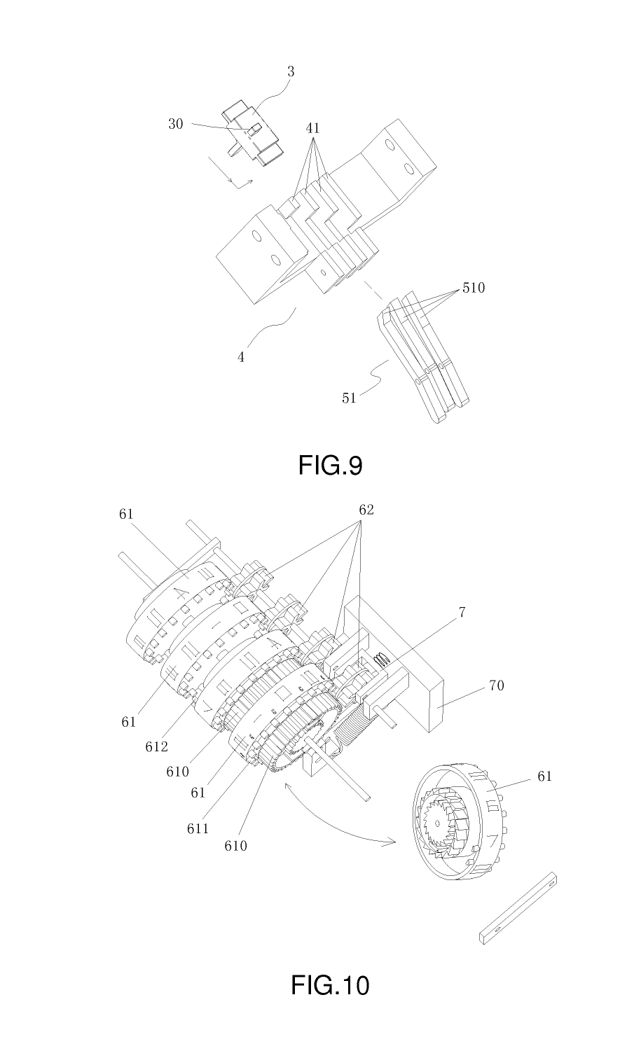

As shown in FIGS. 1-3, the moveable end of the present invention is a moveable fender 2, which reciprocates along the direction of the coin slot of the frame and is provided with a lateral chute for receiving the mover 3; the moveable end, while moving horizontally and linearly, drives the mover to move vertically, the mover also having interaction with a slope spring leaf 32 and a compression spring 33 to form a composite-slash-track traveling path, the movement of the mover 3 being also restricted by the sorting gate 4. As shown in FIG. 9 or 12, each of the channels of the sorting gate 4 has a blocking gate 41, with blocking length of the blocking gate 41 in the linear movement direction corresponding to diameter of the coin; coins of different diameters cause different distance of linear movement of the moveable end, making the mover 3 jump in translation to make the drive needle enter different channels to achieve the coin denomination identification. As shown in FIG. 9, the blocking gates 41 in the sorting gate are arranged based on the blocking length from small to large, which causes the drive needle 30 to pass the blocking length from small to large during translation from small to large, making characteristic diameter of each coin correspond to a characteristic return channel. As shown in FIG. 1 or 3, the moveable fender 2 is connected on both ends with the frame 1 through a tension spring 10 to get reset after the coin is deposited, with the moveable end producing a maximum translation corresponding to the coin diameter in the process of the coin passing the coin slot; the drive needle 30 of the mover 3 in the fender enters different return channels after the maximum jump translation, and then acts on a drive rod slope 510 and is in linkage to the coin denomination summation mechanism to achieve the coin denomination summation memory; the drive needle 30 gets separated when reaching the end of the drive rod slope, and moves back to the initial position under the action of the compression spring 33, thus completing the cycle.

As shown in FIGS. 9, 12 and 13, the drive mechanism 5 of the present invention, as a gear engaging mechanism, comprises a sector gear set, wherein the sector gear has a trigger end 500 that has interaction with the drive rod 51 to receive the coin sorting characteristic signal, and tooth portion of the sector gear is engaged with a gear 610 on the side of the counter wheel and drives the counter wheel to achieve the coin denomination summation memory. The coin denomination summation mechanism includes a set of one-way rotary counter wheels 61, with each of the counter wheels marked on its annular ring with a scale. As shown in FIG. 3 or 10, the counter wheels compose a group of digits indicating denomination of the deposited coin; each of the counter wheels is provided inside with a one-way positioning ratchet, with the counter wheels of units and tens provided with a one-way drive ratchet; a drive mechanical signal to which mechanical sorting denomination of the coin denomination identification mechanism corresponds acts on an outer gear of the ratchet of units or tens through the drive mechanism and drives the counter wheel to rotate; each of the counter wheels is provided on the right periphery with several count linkage teeth 611 and on the left periphery with a carry linkage tooth 612, with a linkage wheel 62 provided between the adjacent counter wheels for linkage carry: wherein a wheel of units is used for summation of 1-dime coins, driven by one drive rod, and used for summation of a whole unit, doing carry linkage on the wheel of tens once reaching ten units; a wheel of tens is used for summation of 5-dime and 10-dime (1-dollar) coins, and driven by two drive rods, having a whole-unit carry and a semi-unit carry, producing carry linkage with the wheel of hundreds once reaching ten, or doing carry per 0.5 unit and completing carry by two linkages.

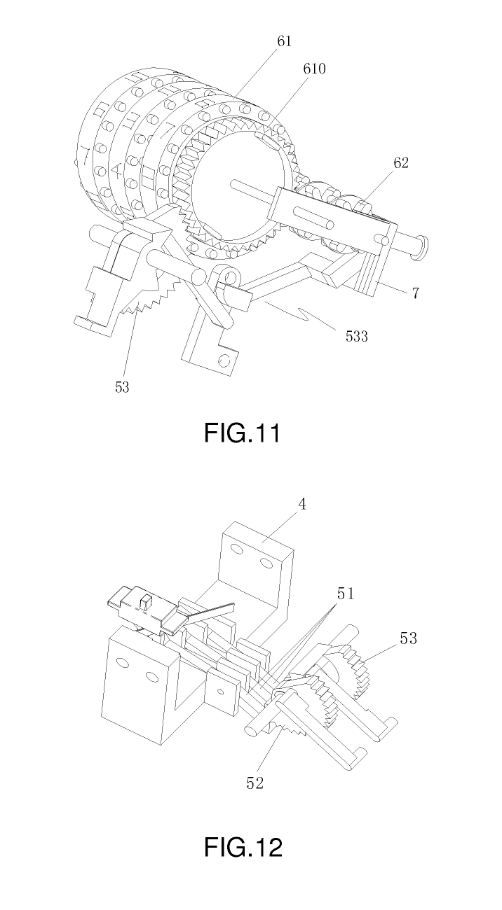

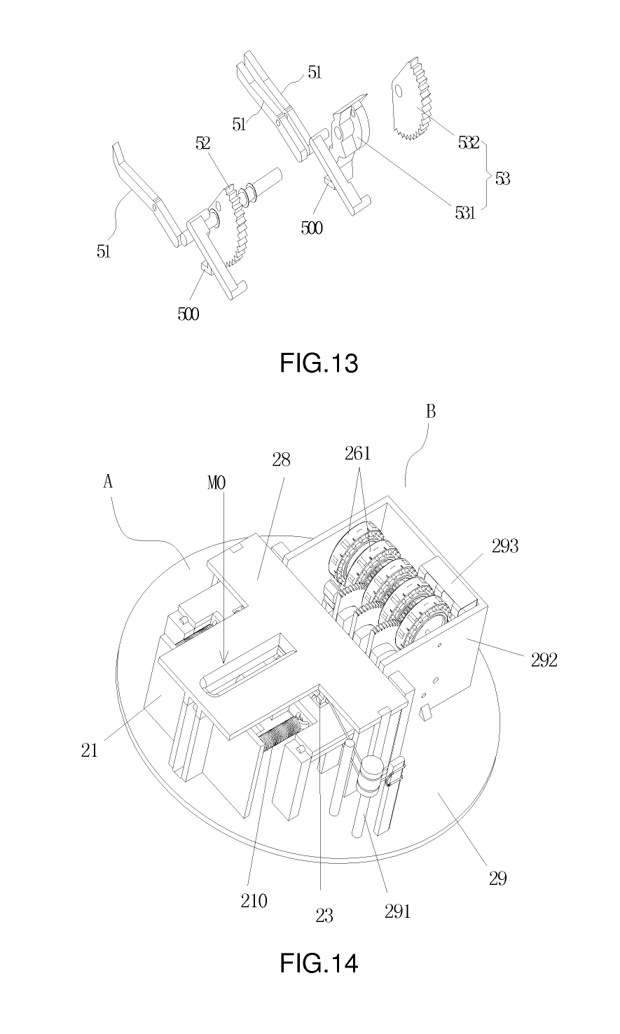

As shown in FIGS. 12 and 13, the sector gear set of the drive mechanism of the present invention comprises a first drive wheel 52 and a second compound wheel 53, both of which are blocked on one side to the initial position; the first drive wheel 52, having interaction with a drive rod and being in linkage with the wheel of units, is provided with a reset connection hole for connecting a connecting rod 521 and a spring 520 and elastically fixes the base; the second compound wheel 53 has interaction with the two drive rods to be in linkage with the wheel of tens; the second compound wheel 53 is composed of an active wheel 531 and a passive sector wheel 532, the active wheel being provided with a reset connection hole for connecting the connecting rod 521 and the spring 520 and elastically fixed in the initial position, the passive sector wheel 532 being in differential drive with the active wheel 531; the drive rod has mechanical action on the active wheel 531; the active wheel, when going through a rotating difference process with the passive sector wheel, delivers a mechanical signal through a clutch connecting rod mechanism 533, which acts on a clutch frame 7 of the linkage wheel on the counter wheel to get the linkage wheel 62 separated/reunited. As shown in FIG. 11, the active wheel, after differential rotation relative to the passive wheel, gets in linkage with the passive sector wheel, and gets engaged and in linkage with the drive ratchet on the counter wheel through this sector wheel; the linkage wheel 62 between the counter wheels of units and tens is mounted on the clutch frame 7, which is positioned on the base 70 by the elastic member and controlled by the active wheel 531 of the second compound wheel 53, with the linkage wheel separated from the counter wheel during the carry interference.

The coin denomination identification mechanism of the present invention comprises a frame provided at an end with a coin slot MO, which has a moveable fender at the other end; the moveable fender slides back and forth along the chute of a beam on both sides of the frame, with the sorting gate fixed on the crossbeam of the frame; the fender is provided at its center with an indentation, which is provided on the front and rear sides with a chute, with the mover disposed in the indentation and being in lateral translation along the chute; the mover has a shaft extending out from the upper and bottom sides and is limited by the slope spring leaf for translation, with the fixed side of the slope spring leaf disposed on the side wall of the protrusion of the sorting gate.

The coin denomination summation mechanism B of the present invention includes a set of one-way rotary counter wheels 61, each of the counter wheels being marked on its annular ring with the scales 0, 1, 2, 3, 4, 5, 6, 7, 8 and 9, the counter wheels composing a group of digits for indicating denomination of the deposited coin.

The coin deposit and summation memory device of the present invention can achieve identification and summation of 20-ary, 40-ary or 50-ary coin denomination, which corresponds to a minimum scale of 0.50 unit, 0.25 unit and 0.20 unit, respectively. The present invention, based on diameter features of different coin denominations, determines different mechanical action characteristic circulations, with a different mechanical feature circulation path driving a characteristic mechanical signal/mechanical action corresponding to the coin denomination; the characteristic mechanical signal corresponding to the coin denomination drives a mechanical counter wheel that, according to the characteristic mechanical signal, does the data summation once that corresponds to the coin denomination.

The present invention mainly comprises a mechanical structure for circularly identifying coin denomination (a coin denomination identification mechanism) and a coin denominations summation mechanism:

I. The Mechanical Structure for Circularly Identifying Coin Denomination:

The mechanical structure for circularly identifying coin denomination is provided with a coin slot, which is immovable on one end and moveable on the other end to adapt to different diameters of deposited coins; the moveable end is provided with a mover that can move left and right, with the mover provided with a drive needle; the drive needle is provided at its top with a sorting gate, which has more than one channels respectively corresponding to different denominations of coins; the moveable end, while moving linearly, drives the mover to move linearly, with the mover provided on both sides with the slope spring leaf and the compression spring, respectively; the mover, while moving linearly, is subjected more to a lateral component force of the slope spring leaf than the force of the compression spring, which makes the mover have translation that is restricted by the sorting gate; each of the channels of the sorting gate has a blocking gate, with blocking length of the blocking gate in the linear movement direction corresponding to diameter of the coin; coins of different diameters cause different distance of linear movement of the moveable end, making the mover jump in translation to make the drive needle enter different channels to achieve the coin denomination identification.

The moveable end is provided with a mover, which can have lateral translation; the mover, when entering the end of the sorting gate, is subjected to an oblique force of the relatively fixed slope spring leaf as well as the force of the compression spring moving together with the mover, with the force resolved from the oblique force of the slope spring leaf and repulsive to the spring being greater than the force of the compression spring; at the initial end of the sorting gate, the slope spring leaf is not in contact with the mover, which is free from a force.

The coin denomination identification mechanism comprises a frame provided at an end with a coin slot, which has a moveable fender at the other end, with the moveable fender fixed to the moveable end; while a coin passes the coin slot, the moveable end makes the maximum translation corresponding to diameter of the coin, and the mover in the moveable end enters different return channels after the maximum translation; the blocking gates in the sorting gate are arranged based on the blocking length from small to large, which causes the drive needle to pass the blocking length from small to large during translation from small to large, making characteristic diameter of each coin correspond to a characteristic return channel.

II. The Coin Denomination Summation Mechanism:

The coin denomination summation portion of the present invention is a set of 20-ary counter wheels, which rotate unidirectionally, have the minimum scale of 0.5, and are marked with 0.5 at the ten's place to represent summation of 5 dimes (0.5 dollar); the counter wheel is provided inside with a one-way 20-tooth positioning ratchet, with the counter wheels of units and tens provided with a 20-tooth one-way drive ratchet; the drive mechanical signal to which the mechanically sorted denomination corresponds gets in linkage with the counter wheel by gear engagement; the wheel of units is used for summation of the whole-unit carry, doing carry linkage on the wheel of tens once reaching ten units (1 dime); the wheel of tens has the whole-unit carry (1 dollar) and the semi-unit carry 0.5 (5-dime unit carry), producing carry linkage with the wheel of hundreds once reaching ten, or doing carry per 0.5 unit and completing carry by two linkages.

The present invention will encounter a problem of carry linkage while in use, with the carry linkage transmitted to the linkage tooth of the carried wheel by the linkage tooth of the carry wheel through the linkage wheel to cause linkage of the carried wheel; specifically, in the process of carry from units to tens, the linkage tooth causes the drive wheel to rotate, which will generate interference bits for the tooth of the wheel of units in the rear; in order to eliminate the interference, the linkage wheel between the counter wheels of units and tens is designed to be as follows: a clutch device is attached, the linkage wheel is mounted on the clutch frame, and the clutch frame is positioned on the base to get separated/reunited elastically by the spring.

The solution of solving the carry linkage is specifically as follows:

The second compound wheel is composed of an active wheel and a passive sector wheel, the active wheel being provided with a reset connection hole for connecting a spring and elastically fixed in the initial position, the passive sector wheel being in differential drive with the active wheel, the drive rod having mechanical action on the active wheel; the active wheel, when going through a rotating difference process with the passive sector wheel, delivers a mechanical signal, which acts on a clutch frame of the linkage wheel on the counter wheel to get the linkage wheel separated/reunited; the active wheel, after differential rotation relative to the passive wheel, gets in linkage with the passive sector wheel, and gets engaged and in linkage with the drive ratchet on the counter wheel through this sector wheel; the counter wheel, doing the summation of the carry wheel, does not interfere with the rear wheel but does summation to the front wheel.

The present invention achieves the 20-ary, 40-ary and 50-ary characteristic parameters:

| | 20-ary | 40-ary | 50-ary |
|---|---|---|---|
| Minimum scale | 0.50 | 0.25 | 0.20 |
| Number of teeth of the | 20 teeth | 40 teeth | 50 teeth |
| positioning ratchet | | | |
| Carry linkage times | 2 times | 4 times | 5 times |
| Rotation angle of the | 18 degrees | 9 degrees | 7.2 degrees |
| minimum scale | | | |

### Example 2

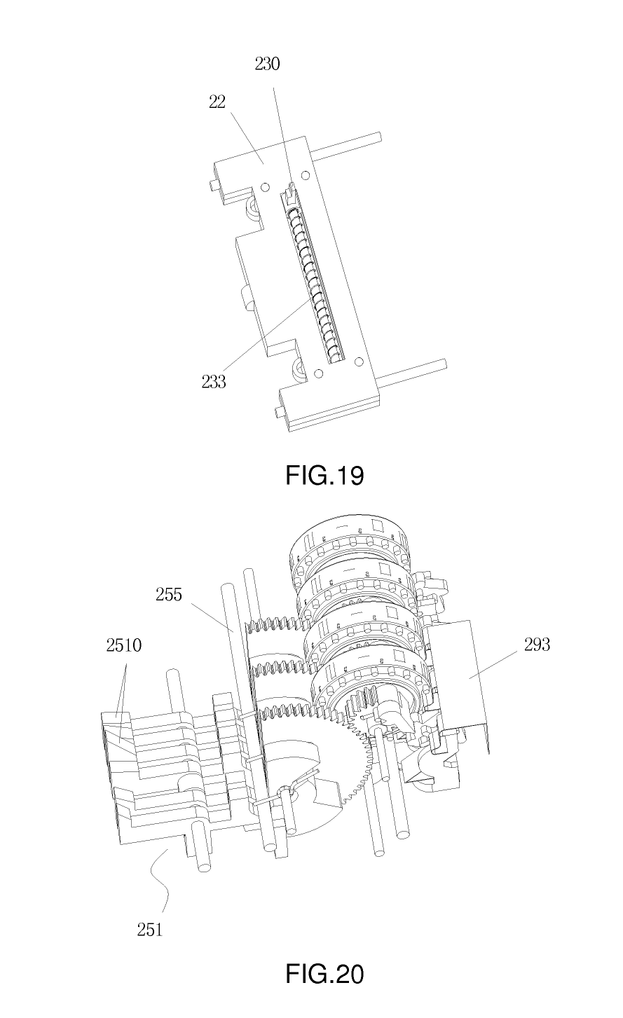

As shown in FIGS. 14 to 19, a coin deposit and summation memory device is provided, comprising a coin denomination identification mechanism A and a coin denomination summation mechanism B, with the coin denomination identification mechanism and the coin denomination summation mechanism disposed on a chassis 29, wherein:

the coin denomination identification mechanism A includes a frame 21 provided at an end with a coin slot MO, which has a moveable end (a moveable frame 22) to adapt to different diameters of deposited coins; the moveable end is provided with a mover 23 having a drive needle 230, with the mover 23 moving along a composite slash track and cooperating with a sorting gate 24 to perform sorting operation on different denominations of coins; the sorting gate 24 has more than one channels respectively corresponding to different denomination of coins, with each of the channels provided with a drive rod 251 that has interaction with the drive needle 230 entering the channel to thereby generate a characteristic signal corresponding to the coin denomination; and

the coin denomination summation mechanism B includes a set of one-way rotary counter wheels 261, with the counter wheels of units, tens and hundreds provided with a one-way drive ratchet; the ratchet is connected with a drive mechanism 25 to receive the characteristic signal sent from the coin denomination identification mechanism and correspondingly drives to thus achieve the coin denomination summation memory.

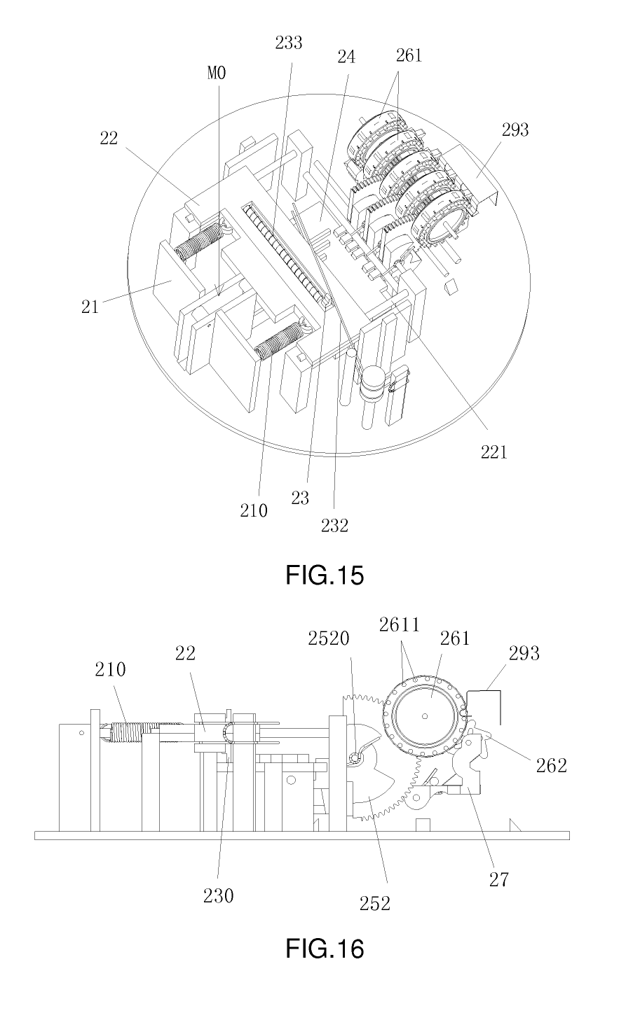

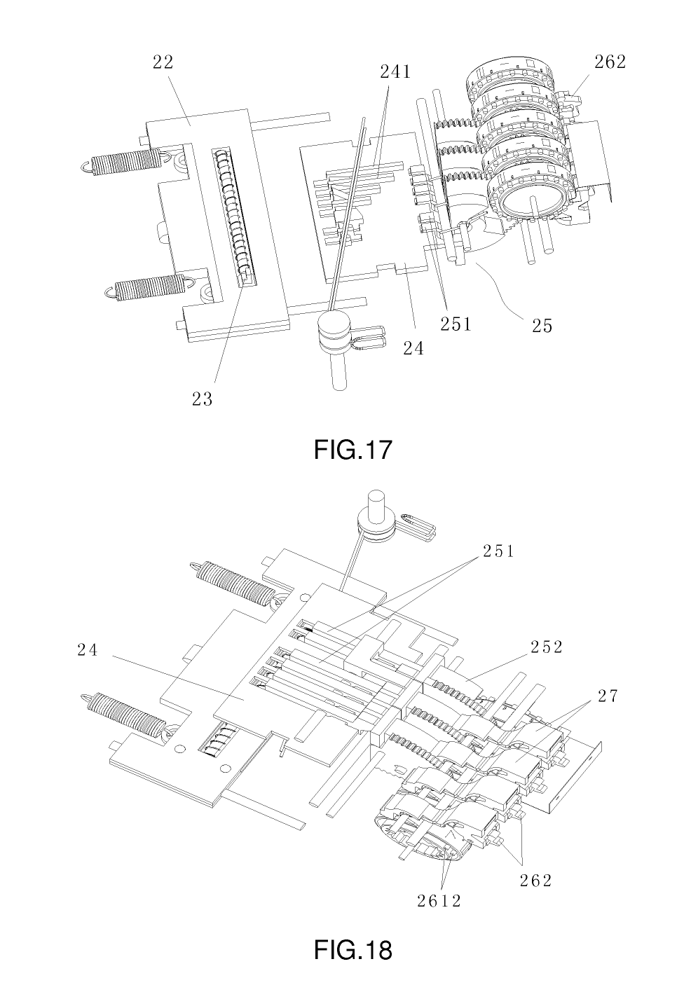

As shown in FIGS. 15-17, the moveable end of the present invention is a moveable fender 22, which reciprocates along the direction of the coin slot of the frame and is provided with a lateral chute for receiving the mover 23; the moveable end, while moving horizontally and linearly, drives the mover to move vertically, the mover also having interaction with a slope spring 232 and a compression spring 233 to form a composite-slash-track traveling path, the movement of the mover 23 being also restricted by the sorting gate 24. As shown in FIG. 17, each of the channels of the sorting gate 24 has a blocking gate 241, with blocking length of the blocking gate 241 in the linear movement direction corresponding to diameter of the coin; coins of different diameters cause different distance of linear movement of the moveable end, making the mover 23 jump in translation to make the drive needle enter different channels to achieve the coin denomination identification; the blocking gates 241 in the sorting gate are arranged based on the blocking length from small to large, which causes the drive needle 230 to pass the blocking length from small to large during translation from small to large, making characteristic diameter of each coin correspond to a characteristic return channel. As shown in FIG. 15 or 16, the moveable fender 22 is connected on both ends with the frame 21 through a tension spring 210 to get reset after the coin is deposited; while a coin passes the coin slot, the moveable end makes the maximum translation corresponding to diameter of the coin; the drive needle 230 of the mover 23 in the fender enters different return channels after the maximum jump translation, and then acts on a drive rod slope 2510 and is in linkage to the coin denomination summation mechanism to achieve the coin denomination summation memory; the drive needle 230 gets separated when reaching the end of the drive rod slope, and moves back to the initial position under the action of the compression spring 233, thus completing the cycle.

As shown in FIGS. 14 and 26, the sorting gate 24 is provided above with an upper cover plate 28, which is also provided with a blocking gate that is symmetrical to the blocking gate of the sorting gate 24; cooperation of the sorting gate 24 with the upper cover plate 28 enables the mover 23 to be subjected to a force symmetrically, making the mechanism stable.

As shown in FIGS. 18, 20, 21 and 22, the drive mechanism 25 of the present invention, as a gear engaging mechanism, comprises a sector gear set, wherein the sector gear has a trigger end 2500 that has interaction with the drive rod 251 to receive the coin sorting characteristic signal, and the tooth portion of the sector gear is engaged with a gear 2610 (i.e. a one-way drive ratchet) on the side of the counter wheel and drives the counter wheel to achieve the coin denomination summation memory; there is a scale on each of the counter wheels of the coin denomination summation mechanism, with the counter wheels composing a group of digits indicating denomination of the deposited coin; the counter wheels of units, tens and hundreds are provided with a one-way drive ratchet; a drive mechanical signal to which mechanical sorting denomination of the coin denomination identification mechanism corresponds acts on the outer gear of the one-way drive ratchet of units, tens or hundreds through the drive mechanism and drives the counter wheel to rotate; each of the counter wheels is provided on the right periphery with several count linkage teeth 2611 and on the left periphery with a carry linkage tooth 2612, with a linkage wheel 262 provided between the adjacent counter wheels for linkage carry. Wherein the wheel of units is used for summation of 1-cent coins, driven by one drive rod, and used for summation of a whole unit, doing carry linkage on the wheel of tens once reaching ten units; the wheel of tens is used for summation of 5-cent, 1-dime and 25-cent coins and driven by three drive rods, having a whole-unit carry and a semi-unit carry, producing carry linkage with the wheel of hundreds once reaching ten, or doing carry per 0.5 unit and completing carry by two linkages; the wheel of hundreds is used for summation of 5-dime and 1-dollar coins and driven by two drive rods, having a whole-unit carry and a semi-unit carry, producing carry linkage with the wheel of thousands once reaching ten, or doing carry per 0.5 unit and completing carry by two linkages.

As shown in FIGS. 20 and 22, the sector gear set of the drive mechanism of the present invention comprises a first drive wheel 252, a second compound wheel 253, and a third compound wheel 254, three of which are blocked on one side to the initial position; the first drive wheel 252 has interaction with a drive rod and is in linkage with the wheel of units, delivering one kind of denomination signal; the second compound wheel 253 has interaction with the three drive rods to be in linkage with the wheel of tens, delivering three kinds of denomination signals; the third compound wheel 254 has interaction with the two drive rods to be in linkage with the wheel of hundreds, delivering two kinds of denomination signals. The addition of a set of compound wheels to the drive mechanism of the present invention is for adding a trigger unit of summation, so as to receive trigger to do the summation of 5-dime and 1-dollar coins.

The first drive wheel 252, the second compound wheel 253 and the third compound wheel 254 are all composed of an active wheel and a passive sector wheel; the mechanical action of the drive rod 251 acts on the active wheel, which is provided with a torsion spring 2520 and elastically fixed in the initial position, with one end of the torsion spring 2520 abutting against a first column 255. The sector gear set uses the torsion spring 2520 instead to get the active wheel reset, thus saving space and making the mechanism more compact.

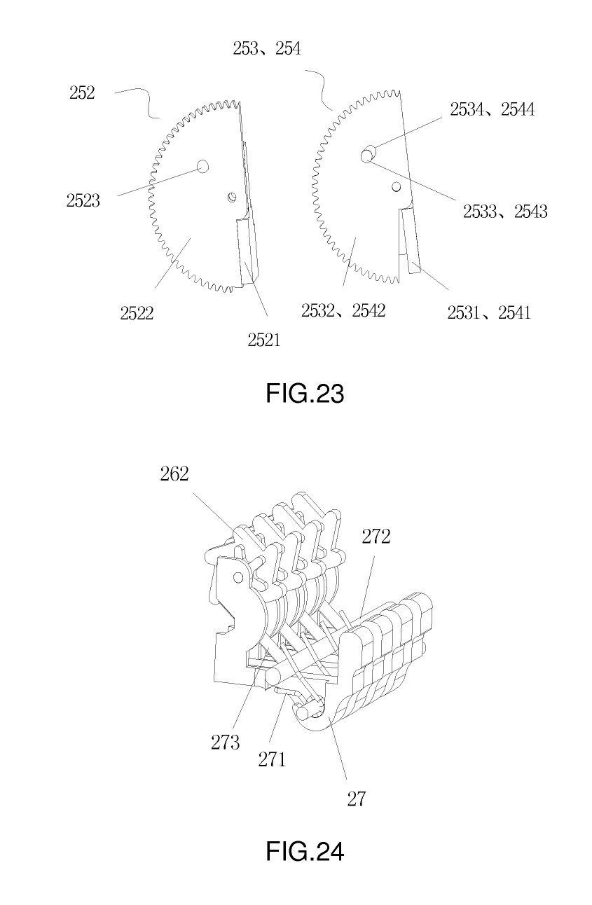

As shown in FIGS. 22 and 23, the active wheel 2521 of the first drive wheel 252 is provided with a lug 2523, which is inserted into the mounting hole 2524 of the passive sector wheel 2522 of the first drive wheel 252, with the lug 2523 on the active wheel 2521 of the first drive wheel 252 acting inside the mounting hole 2524 and driving the passive sector wheel 2522 to rotate.

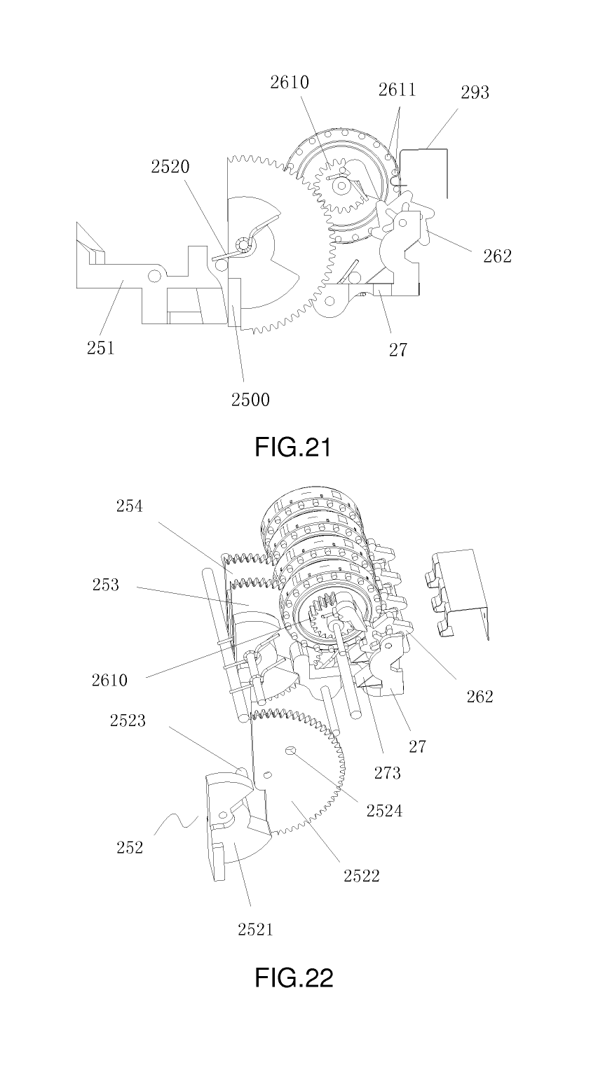

As shown in FIG. 23, the active wheels of the second compound wheel 253 and the third compound wheel 254 are also provided with a lug, respectively, the lug 2533 on the active wheel 2531 of the second compound wheel 253 being located in a differential hole 2534 of the passive sector wheel 2532 of the second compound wheel 253, the lug 2543 on the active wheel 2541 of the third compound wheel 254 being located in a differential hole 2544 of the passive sector wheel 2542 of the third compound wheel 254, with the lug on the active wheel of the second compound wheel 253 and the third compound wheel 254 able to be relatively displaced in the corresponding differential hole, thus achieving differential drive with the passive sector wheel; the active wheel of the second compound wheel 253 and the third compound wheel 254, in the process of rotation difference with the passive sector wheel, delivers a mechanical signal, which acts on a clutch frame 27 of the linkage wheel 262 on the counter wheel to get the linkage wheel 262 separated/reunited. As shown in FIG. 21, the active wheel, after differential rotation relative to the passive sector wheel, gets in linkage with the passive sector wheel, and gets engaged and in linkage with the one-way drive ratchet on the counter wheel through this passive sector wheel.

The linkage wheels between the counter wheels are mounted on the clutch frame 27 to which they respectively correspond, with the clutch frame 27 positioned by the elastic member; the elastic member is preferably a torsion spring 271, both ends of which abut against the clutch frame 27 and the second column 272, respectively, advantageous to saving space. The active wheel of the second compound wheel 253 controls the clutch frame to which the linkage wheel between the counter wheels of units and tens corresponds, and the active wheel of the third compound wheel 254 controls the clutch frame to which the linkage wheel between the counter wheels of tens and hundreds corresponds, making the linkage wheel separated from the counter wheel during the carry interference.

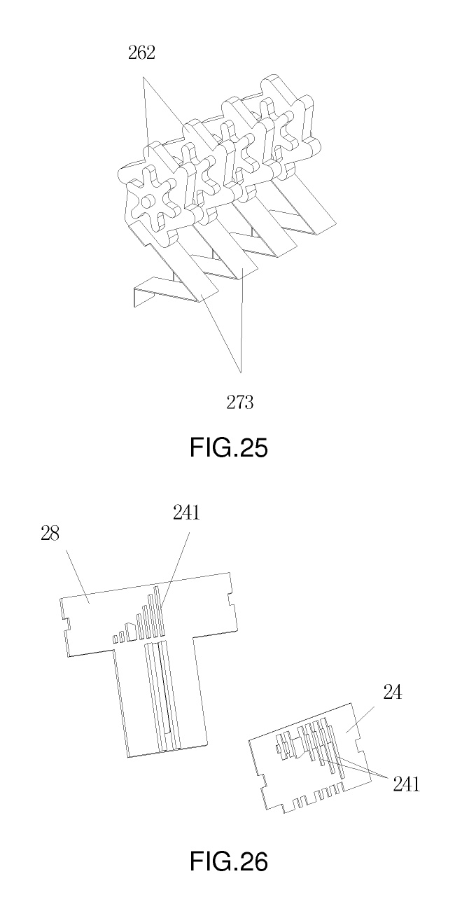

As shown in FIGS. 24 and 25, the clutch frame 27 is provided with a positioning elastic sheet 273, one end of which acts on the tooth position of the linkage wheel 262; the positioning elastic sheet 273 can improve the mechanical stability, and eliminate the drift that may occur after separation of the linkage wheel from the counter wheel.

Besides, as shown in FIGS. 15, 21 and 22, the coin denomination summation mechanism also comprises a one-way clipping spring leaf 293, which is mounted on a mounting seat 292 of the coin denomination summation mechanism; the spring leaf of the one-way clipping spring leaf 293 cooperates in positioning with the count linkage tooth 2611 on the right periphery of the counter wheel, which is equal to the outer ratchet positioning, but is more convenient to produce and saves space.

The coin denomination identification mechanism of the present invention comprises a frame provided at an end with a coin slot MO, which has a moveable fender at the other end; the movable fender slides back and forth along a guide post 221 on both sides of the frame, with the sorting gate fixed on the crossbeam of the frame; the fender is provided at its center with an indentation, which is provided on the front and rear sides with a chute, with the mover disposed in the indentation and being in lateral translation along the chute; the mover has a shaft extending out from the upper and bottom sides and is limited by the slope spring 232 and the blocking gate 241 for jumping and making translation, with the slope spring fixed at one end to a mounting post 291 of the chassis 29.

The coin deposit and summation memory device of the present invention can achieve identification and summation of 20-ary, 40-ary or 50-ary coin denomination, which corresponds to a minimum scale of 0.50 unit, 0.25 unit and 0.20 unit, respectively. The present invention, based on diameter features of different coin denominations, determines different mechanical action characteristic circulations, with a different mechanical feature circulation path driving a characteristic mechanical signal/mechanical action corresponding to the coin denomination; the characteristic mechanical signal corresponding to the coin denomination drives a mechanical counter wheel that, according to the characteristic mechanical signal, does the data summation once that corresponds to the coin denomination.

The present invention is different from the existing solution in function and structure as follows:

I. Difference in Function:

1. The present invention, having mechanical memorizing function, does not need electrical energy and can memorize permanently; the existing intelligent memory needs power supply and consumes a battery, with the battery needing to be replaced when used up.

2. The present invention achieves the coin denomination summation memory, with the output result being in **hundred*ten dollars*dollar*dime*cent or **thousand**hundred*ten dollars*dollar*dime*cent; the existing intelligent memory can only do the summation of units, with the output results being in *units;

II. Difference in Structure:

1. The present invention has a pure mechanical structure, while the existing intelligent memory moneybox is composed of an electronic circuit board and an LCD screen.

2. The present invention achieves the mechanical coin denomination identification, with the same coin slot receiving coins and outputting the characteristic mechanical action circulation corresponding to different denominations of coins.

3. The mechanical counter wheels of the present invention are relatively independent in the working state at tens and units or hundreds, tens and units, achieving cross-ary summation, i.e., 1 dollar is equivalent to 10 dimes and 1 is added on the counter wheel of tens; the existing counter for the number of coins has a traditional counter structure, not allowing the cross-ary summation.

4. The mechanical summation wheel of the present invention can achieve the cross-ary summation that does not interfere with the rear wheel but does the summation forward.

5. The present invention, using the fraction-ary, provides the non-decimal summation that is applied to the coin summation, and relates to a 20-ary 0.5-unit counter wheel; by changing the number of teeth of the corresponding gear, the same thought and structure can be applied to the 40-ary 0.25-unit summation, which is applied to summation of the coins similar to 25 cents (US$0.25); the same thought and structure can be applied to the 50-ary 0.2-unit summation, which is applied to summation of the coins similar to 20 euro cents (0.2 euro); the existing counter wheel is a traditional decimal counter wheel, which can do neither the 0.5-unit summation nor the 0.25-unit or the 0.2-unit summation.

The present invention has the following main features:

1. The present invention has the mechanical coin denomination summation memory function, with a coin slot for receiving coins and a counter device for displaying the summation result of the deposited coins.

2. The device of the present invention has the non-integral fraction summation function, solving the problem of 0.5-unit, 0.25-unit and 0.2-unit coin summation.

3. The present invention is a universal device having a whole-mechanical structure, which distinguishes according to the coin diameter feature, determines the denomination based on the coin diameter, and does the summation.

4. The present invention adopts a cross-ary summation counter wheel, i.e. a non-integral summation counter wheel.

What are described above are only examples used for explaining the technical contents of the present invention. Any modification and alteration made by those skilled in the art belongs to the scope of protection of the present invention, which is not limited to what is disclosed in the examples.

What is claimed is:

1. A coin deposit and summation memory device, characterized in that: this device comprises a coin denomination identification mechanism and a coin denomination summation mechanism, wherein:
the coin denomination identification mechanism includes a frame provided at an end with a coin slot, which has a moveable end to adapt to different diameters of deposited coins; the moveable end is provided with a mover having a drive needle, with the mover moving along a composite slash track and cooperating with a sorting gate to perform sorting operation on different denominations of coins; the sorting gate has more than one channels respectively corresponding to different denominations of coins, with each of the channels provided with a drive rod that has interaction with the drive needle entering the channel to thereby generate a characteristic signal corresponding to the coin denomination;
the coin denomination summation mechanism includes a set of one-way rotary counter wheels, with a one-way drive ratchet provided on a counter wheel of units and tens or a counter wheel of units, tens and hundreds; the ratchet is connected with a drive mechanism to receive the characteristic signal sent from the coin denomination identification mechanism and correspondingly drives to thus achieve the coin denomination summation memory.

2. The coin deposit and summation memory device according to claim 1, characterized in that: the moveable end is a moveable fender, which reciprocates along the direction of the coin slot of the frame and is provided with a lateral chute for receiving the mover; the moveable end, while moving horizontally and linearly, drives the mover to move vertically, with the mover also having interaction with a slope elastic member and a compression spring to form a composite-slash-track traveling path; the movement of the mover is also restricted by the sorting gate, with each of the channels of the sorting gate having a blocking gate; with blocking length of the blocking gate in the linear movement direction corresponding to diameter of the coin, coins of different diameters cause different distance of linear movement of the moveable end, making the mover jump in translation to make the drive needle enter different channels to achieve the coin denomination identification.

3. The coin deposit and summation memory device according to claim 2, characterized in that: the slope elastic member comprises a slope spring leaf or a slope spring.

4. The coin deposit and summation memory device according to claim 2, characterized in that: the blocking gates in the sorting gate are arranged based on the blocking length from small to large, which causes the drive needle to pass the blocking length from small to large during translation from small to large, making characteristic diameter of each coin correspond to a characteristic return channel.

5. The coin deposit and summation memory device according to claim 2, characterized in that: the moveable fender is connected on both ends with the frame through a tension spring to get reset after the coin is deposited, with the moveable end producing a maximum translation corresponding to the coin diameter in the process of the coin passing the coin slot; the drive needle of the mover in the fender enters different return channels after the maximum jump translation, and then acts on a drive rod slope and is in linkage to the coin denomination summation mechanism to achieve the coin denomination summation memory; the drive needle gets separated when reaching the end of the drive rod slope, and moves back to the initial position under the action of the compression spring, thus completing the cycle.

6. The coin deposit and summation memory device according to claim 1, characterized in that: the drive mechanism, as a gear engaging mechanism, comprises a sector gear set, wherein the sector gear has a trigger end that has interaction with the drive rod to receive the coin sorting characteristic signal, and tooth portion of the sector gear is engaged with a gear on the side of the counter wheel and drives the counter wheel to achieve the coin denomination summation memory.

7. The coin deposit and summation memory device according to claim 1, characterized in that: there is a scale on each of the counter wheels of the coin denomination summation mechanism, with the counter wheels composing a group of digits for indicating denomination of the deposited coin; each of the counter wheels is provided inside with a one-way positioning ratchet, with the counter wheels of units and tens provided with a one-way drive ratchet; a drive mechanical signal to which mechanical sorting denomination of the coin denomination identification mechanism corresponds acts on an outer gear of the ratchet of units or tens through the drive mechanism and drives the counter wheel to rotate; each of the counter wheels is provided on the right periphery with several count linkage teeth and on the left side with a carry linkage tooth, with a linkage wheel provided between the adjacent counter wheels for linkage carry:
a wheel of units, driven by one drive rod, used for summation of a whole unit, doing carry linkage on the wheel of tens once reaching ten units;
a wheel of tens, driven by two drive rods, having a whole-unit carry and a semi-unit carry, producing carry linkage with the wheel of hundreds once reaching ten, or doing carry per 0.5 unit and completing carry by two linkages.

8. The coin deposit and summation memory device according to claim 6, characterized in that: the sector gear set comprises a first drive wheel and a second compound wheel, both of which are blocked on one side to the initial position; the first drive wheel has interaction with a drive rod and is in linkage with the wheel of units, delivering one kind of denomination signal; the second compound wheel has interaction with the two drive rods to be in linkage with the wheel of tens, delivering two kinds of denomination signals.

9. The coin deposit and summation memory device according to claim 8, characterized in that: the second compound wheel is composed of an active wheel and a passive sector wheel, the active wheel being provided with a reset connection hole for connecting a spring and elastically fixed in the initial position, the passive sector wheel being in differential drive with the active wheel, the drive rod having mechanical action on the active wheel; the active wheel, when going through a rotating difference process with the passive sector wheel, delivers a mechanical signal, which acts on a clutch frame of the linkage wheel on the counter wheel to get the linkage wheel separated/reunited; the active wheel, after differential rotation relative to the passive wheel, gets in linkage with the passive sector wheel, and gets engaged and in linkage with the drive ratchet on the counter wheel through this sector wheel.

10. The coin deposit and summation memory device according to claim 7, characterized in that: the linkage wheel between the counter wheels of units and tens is mounted on the clutch frame, which is positioned on a base by the elastic member and controlled by the active wheel of the second compound wheel, with the linkage wheel separated from the counter wheel during carry interference.

11. The coin deposit and summation memory device according to claim 1, characterized in that: there is a scale on each of the counter wheels of the coin denomination summation mechanism, the counter wheels composing a group of digits for indicating denomination of the deposited coin, the counter wheels of units, tens and hundreds being provided with a one-way drive ratchet; a drive mechanical signal to which mechanical sorting denomination of the coin denomination identification mechanism corresponds acts on an outer gear of the ratchet of units, tens or hundreds through the drive mechanism and drives the counter wheel to rotate; each of the counter wheels is provided on the right periphery with several count linkage teeth and on the left side with a carry linkage tooth, with a linkage wheel provided between the adjacent counter wheels for linkage carry:
a wheel of units, driven by one drive rod, used for summation of a whole unit, doing carry linkage on the wheel of tens once reaching ten units;
a wheel of tens, driven by three drive rods, having a whole-unit carry and a semi-unit carry, producing carry linkage with the wheel of hundreds once reaching ten, or doing carry per 0.5 unit and completing carry by two linkages;
a wheel of hundreds, driven by two drive rods, having a whole-unit carry and a semi-unit carry, producing carry linkage with the wheel of thousands once reaching ten, or doing carry per 0.5 unit and completing carry by two linkages.

12. The coin deposit and summation memory device according to claim 6, characterized in that: the sector gear set comprises a first drive wheel, a second compound wheel, and a third compound wheel, three of which are blocked on one side to the initial position; the first drive wheel has interaction with a drive rod and is in linkage with the wheel of units, delivering one kind of denomination signal; the second compound wheel has interaction with the three drive rods to be in linkage with the wheel of tens, delivering three kinds of denomination signals; the third compound wheel has interaction with the two drive rods to be in linkage with the wheel of hundreds, delivering two kinds of denomination signals.

13. The coin deposit and summation memory device according to claim 12, characterized in that: the first drive wheel, the second compound wheel and the third compound wheel are all composed of an active wheel and a passive sector wheel; the active wheel is provided with a torsion spring and elastically fixed in the initial position, with one end of the torsion spring abutting against a first column; the drive rod has mechanical action on the active wheel, which is provided with a lug; wherein the lug on the active wheel of the first drive wheel is inserted into a mounting hole of the passive sector wheel of the first drive wheel, the lug on the active wheel of the second compound wheel is located in a differential hole of the passive sector wheel of the second compound wheel, and the lug on the active wheel of the third compound wheel is located in a differential hole of the passive sector wheel of the third compound wheel, with the lug on the active wheel of the second compound wheel and the third compound wheel able to be relatively displaced in the differential hole, thus achieving differential drive with the passive sector wheel; and the active wheel of the second compound wheel and the third compound wheel, in the process of rotation difference with the passive sector wheel, delivers a mechanical signal, which acts on a clutch frame of the linkage wheel on the counter wheel to get the linkage wheel separated/reunited; the active wheel, after differential rotation relative to the passive wheel, gets in linkage with the passive sector wheel, and gets engaged and in linkage with the drive ratchet on the counter wheel through this sector wheel.

14. The coin deposit and summation memory device according to claim 11, characterized in that: the linkage wheels between the counter wheels are mounted on the clutch frame to which they respectively correspond, with the clutch frame positioned by the elastic member; the active wheel of the second compound wheel controls the clutch frame to which the linkage wheel between the counter wheels of units and tens corresponds, and the active wheel of the third compound wheel controls the clutch frame to which the linkage wheel between the counter wheels of tens and hundreds corresponds, making the linkage wheel separated from the counter wheel during the carry interference.

15. The coin deposit and summation memory device according to claim 14, characterized in that: the clutch frame is provided with a positioning elastic sheet, one end of which acts on tooth position of the linkage wheel; the coin denomination summation mechanism also comprises a one-way clipping spring leaf, whose spring leaf cooperates in positioning with the count linkage tooth on the right periphery of the counter wheel.

16. The coin deposit and summation memory device according to claim 2, characterized in that: the sorting gate is provided above with an upper cover plate, which is provided with a blocking gate that is symmetrical to the blocking gate of the sorting gate so as to make the mover subjected to a force symmetrically; the coin denomination identification mechanism and the coin denomination summation mechanism are disposed on a chassis.

17. The coin deposit and summation memory device according to claim 1, characterized in that: the coin deposit and summation memory device can achieve identification and summation of 20-ary, 40-ary or 50-ary coin denomination, which corresponds to a minimum scale of 0.50 unit, 0.25 unit and 0.20 unit, respectively.
